(19) United States
(12) Patent Application Publication
(10) Pub. No.: US 2026/0021902 A1
(43) Pub. Date: Jan. 22, 2026

(54) AIRCRAFT AUXILIARY POWER UNIT FUEL SUPPLY CIRCUIT EQUIPMENT SURVEILLANCE METHOD AND DEVICE

(71) Applicant: Airbus Operations SAS, TOULOUSE (FR)

(72) Inventor: Thomas CAILLOL, TOULOUSE (FR)

(21) Appl. No.: 19/269,323

(22) Filed: Jul. 15, 2025

(30) Foreign Application Priority Data
Jul. 22, 2024 (FR) FR2408048

(51) Int. Cl. B64D 45/00; B64D 41/00; B64F 5/40

(52) U.S. Cl. CPC B64D 45/00; B64D 41/00; B64F 5/40

(57) ABSTRACT

A method and a system for surveillance of equipment in a fuel supply circuit of an auxiliary power unit of an aircraft. The method includes determining if the fuel supply circuit was during a predetermined period in a configuration such that these conditions were satisfied: (i) the auxiliary power was in an “on” operating state, and ii) the fuel supply circuit was in a “trim tank fueling” operating mode, and (iii) the trim tank had an “empty” fuel filling status, then determining a duration for which the configuration was maintained and, if the duration is above a first predetermined threshold, storing an event, and if a number of events stored is above a second predetermined threshold generating an alert message.

### CROSS-REFERENCES TO RELATED APPLICATIONS

This application claims the benefit of French Patent Application Number FR2408048 filed on Jul. 22, 2024, the entire disclosure of which is incorporated herein by way of reference.

### FIELD OF THE INVENTION

The field of the present disclosure concerns aircraft auxiliary power unit fuel supply circuit equipment surveillance. The invention concerns in particular surveillance of a pressure switch of a fuel supply pipe that is part of a fuel supply circuit of the auxiliary power unit.

### BACKGROUND OF THE INVENTION

In the aeronautical field an auxiliary power unit (APU) is an electrical generator that supplies energy for functions other than propulsion. In particular, it is used to start the main propulsion systems and to produce energy onboard aircraft to supply electrical power when on the ground to various onboard systems (e.g. cabin lighting system, air-conditioning system, ventilation system, etc.) when the main propulsion systems are not functioning.

An APU is generally supplied with fuel via a fuel supply circuit that routes fuel from tanks of the aircraft. Such tanks include, for example, a left-hand internal main tank situated in the left wing of the aircraft or a “trim tank” situated in the tail assembly of the aircraft. Without departing from the context of the invention, the main tank can also be a right-hand internal main tank situated in the right wing of the aircraft. The function of the trim tank is to make it possible to maintain the position of the center of gravity of the aircraft at the center of lift in accordance with the flight parameters and the weights transferred by filling with fuel from the main tanks (e.g. left-hand and right-hand internal tanks) or by draining the fuel therein.

The supply of fuel to the APU is governed in various operating modes depending on the operational status of the aircraft. FIGS. 1A and 1B schematically depict examples of supplying fuel to the APU in different operating modes.

The fuel supply circuit 100 of an APU 107 classically includes a first pump 101 positioned at the level of a fuel pipe 110 of the APU 107. The first pump 101 is adapted to feed fuel to the APU 107 from a part of a fuel supply pipe 104 supplying fuel to a trim tank 106. The fuel supply circuit 100 further includes a second pump 102 adapted to route fuel to the APU from a left-hand internal main tank 105 of the aircraft to a part of the fuel supply pipe 104 feeding the APU 107. The fuel supply circuit 100 further includes a pressure switch 103 positioned on the fuel supply pipe 104. This pressure switch 103 is adapted to measure the pressure of the fuel in the supply pipe 104 and to transmit an electrical signal if a certain pressure threshold of the fuel circulating in the supply pipe 104 has been reached.

In a first or “operation on ground” operating mode (see FIG. 1A), the APU 107 is supplied with fuel from a left-hand internal main tank 105 by means of the second pump 102 in the aircraft. The fuel then circulates from this left-hand internal main tank 105 to the supply pipe 104 feeding the trim tank 106 and then to the fuel pipe 110 and the APU 107. This operating mode is generally used during classic operations of the aircraft on the ground (e.g. while boarding passengers).

In a second or “trim tank fueling” operating mode (FIG. 1B), when the aircraft is on the ground the APU 107 is supplied with fuel via the fuel supply pipe 104 during filling of the trim tank 106 with fuel. To be more specific, when the trim tank 106 is being supplied with fuel an inlet valve 109 of the trim tank 106 is open to cause the fuel to enter the trim tank 106. Some of this fuel intended for the trim tank 106 is then pumped by the first pump 101 into the fuel supply pipe 104 and/or directly into the trim tank 106 to feed the APU 107 with fuel.

When the pressure switch 103 detects a pressure below a predetermined threshold in the fuel supply pipe 104 it transmits an electrical signal in order to cause the fuel supply circuit 100 to switch from a “trim tank fueling” operating mode to an “operation on ground” operating mode. In fact, during the operation of fueling the trim tank 106 too low a pressure in the supply pipe 104 means that the first pump 101 is pumping more fuel than there is in the supply pipe 104 of the trim tank 106. Consequently, not only is the operation of supplying the trim tank 106 with fuel compromised but there is also the risk of the APU 107 no longer being supplied with fuel and therefore shutting down during the operation of fueling the trim tank. Switching to the “operation on ground” operating mode makes it possible not to allow the first pump 101 to empty the supply pipe 104 of the trim tank 106 because it could otherwise eventually pump air if the trim tank 106 no longer contains sufficient fuel, which would shut down the APU 107.

In order to avoid shutting down the APU 107 in the “trim tank fueling” operating mode it is desirable to monitor correct operation of the pressure switch 103 in order not to leave the fuel supply circuit 100 in the “trim tank fueling” operating mode if there is no longer sufficient fuel in the supply pipe 104 and/or in the trim tank 106.

The pressure switch 103 is not an equipment unit under native surveillance (i.e., no data coming directly from sensors for surveillance of this equipment unit is received and analyzed).

It is therefore desirable to alleviate this disadvantage of the prior art.

It is in particular desirable to provide a solution enabling surveillance of an equipment unit such as a pressure switch of a fuel supply circuit of an APU, in particular during operations of fueling a trim tank of an aircraft.

### SUMMARY OF THE INVENTION

There is proposed here a method for surveillance of an equipment unit of a fuel supply circuit of an auxiliary power unit of an aircraft. The method is implemented by a surveillance device in the form of electronic circuitry. The method comprises:
determining if the fuel supply circuit was in a configuration during a predetermined period P such that the following conditions were fulfilled:
(i) the auxiliary power unit was in an “on” operating state, and
(ii) the fuel supply circuit was in a so-called “trim tank fueling” operating mode, and
(iii) the trim tank had a so-called “empty” fuel filling status, —and each time that the fuel supply circuit was in said configuration, determining a duration during which said configuration was maintained and, if said duration determined is above a first predetermined threshold, storing an event indicating that said determined duration was above the first predetermined threshold,
determining for said predetermined period a number of events stored and if said number of events determined is above a second predetermined threshold, then generating an alert message.

This therefore enables indirect surveillance of an equipment unit of a fuel supply circuit of the APU, such as a pressure switch, that is not under native surveillance. It is therefore possible to send an alert message if that equipment unit necessitates action and/or scheduling maintenance thanks to the surveillance of a parameter such as the duration of a particular configuration of the fuel supply circuit of the APU.

In one embodiment the alert message includes a request for maintenance of said equipment unit to be effected and/or scheduled.

In one embodiment the method further includes:
collecting first data representing said operating status of said auxiliary power unit during said predetermined period, said first data consisting of measurements of the rotation speed of the auxiliary power unit, and determining that said auxiliary power unit is in the so-called “on” operating state if a rotation speed measurement is greater than 0,
collecting second data representing said operating mode of said fuel supply circuit during said predetermined period, said second data consisting of the status of an inlet valve of the trim tank, and determining that the operating mode is the “trim tank fueling” mode if the status of the inlet valve is “open”,
collecting third data representing said fuel filling status of the trim tank during said predetermined period, said third data consisting of measurements of the quantity of fuel in the trim tank, and determining that the status of the tank is “empty” if the quantity of fuel is below a predetermined fuel quantity threshold.

In one embodiment the step of storing an event indicating said duration determined being above the first predetermined threshold is carried out so as to store at most only one event for the same use of the aircraft.

There is also proposed here a method for maintenance of an equipment unit of a fuel supply circuit of an auxiliary power unit of an aircraft, said method including:
surveillance of said equipment unit by the surveillance method as described above,
carrying out and/or scheduling maintenance on said equipment unit if an alert message is generated on executing the surveillance method as described above.

There is also proposed here a device for surveillance of an equipment unit of a fuel supply circuit of an auxiliary power unit of an aircraft. The surveillance device includes electronic circuitry configured:
to determine if said fuel supply circuit has been in a configuration during a predetermined period, such that the following conditions were fulfilled:
(i) the auxiliary power was in an “on” operating state, and
(ii) the fuel supply circuit was in a so-called “trim tank fueling” operating mode, and
(iii) the trim tank had a so-called “empty” fuel filling status,
and each time that the fuel supply circuit was in said configuration, to determine a duration during which said configuration was maintained and, if said duration determined is above a first predetermined threshold, to store an event indicating that said determined duration was above the first predetermined threshold,
to determine for said predetermined period a number of events stored and if said number of events determined is above a second predetermined threshold generating an alert message.

In particular, the surveillance device is installed in an operations center or in a maintenance center on the ground receiving data on the operation of the aircraft.

There is also proposed a computer program product including instructions driving execution by a processor of any embodiment of the method as described above when said instructions are executed by the processor. There is also proposed a storage medium for storing such instructions.

### BRIEF DESCRIPTION OF THE DRAWINGS

The features of the invention mentioned hereinabove and others will become more clearly apparent on reading the following description of at least one embodiment, said description being given with reference to the appended drawings, in which:

FIG. 1A and FIG. 1B schematically depict examples of supplying the APU with fuel in various operating modes;

FIG. 2 is a graph showing a duration of a configuration of the fuel supply circuit of an APU liable to precede sudden shutting down of the APU before and after replacing the pressure switch of the fuel supply circuit;

FIG. 3 is a diagram depicting the steps of one embodiment of a method for surveillance of an equipment unit of a fuel supply circuit of an APU;

FIG. 4 depicts schematically an example of a hardware architecture of one embodiment of a surveillance device.

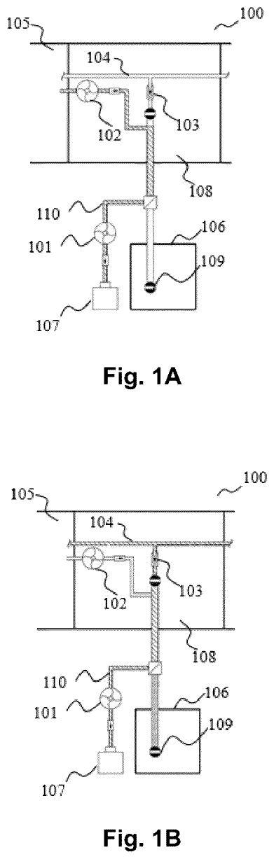

### DETAILED DESCRIPTION OF THE PREFERRED EMBODIMENTS

The general principle of the present disclosure is for indirect surveillance of an equipment unit of a fuel supply circuit of an APU of an aircraft such as a pressure switch. It is therefore possible, if necessary, to issue an alert message if a need to maintain that equipment unit (e.g. a pressure switch) becomes apparent.

It has previously been found that the APU 107 shuts down most often on the ground during operations of fueling the trim tank 106, preceded by a configuration of the fuel supply circuit 100 under the following conditions: the APU 107 is maintained in a so-called “on” operational state when the fuel supply circuit 100 is in a “trim tank fueling” operating mode (i.e., when the trim tank 106 is being fueled) and a status of the trim tank 106 is “empty”, that is to say the quantity of fuel is below a predetermined quantity of fuel Q threshold of the trim tank 106.

Hereinafter, this configuration of the fuel supply circuit 100 is called the “pre APU shutdown configuration”.

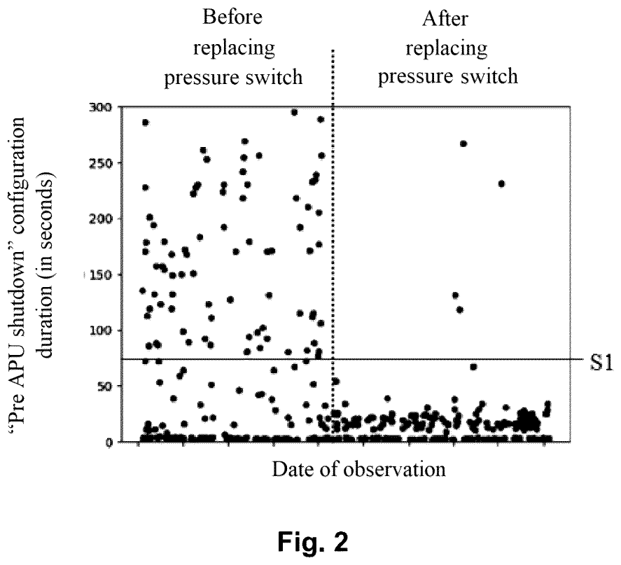

FIG. 2 is a graph depicting a duration of an APU fuel supply circuit configuration preceding sudden shutting down of the APU before and after replacement of the fuel supply circuit pressure switch.

In FIG. 2, before the pressure switch 103 is replaced, the number of occasions of sudden shutting down of the APU 107 that are preceded by the “pre APU shutdown configuration”, the duration of which is greater than a first predetermined threshold S1, is greater than the number of occasions of shutting down after the pressure switch 103 is replaced. In other words, the greater the duration of this “pre APU shutdown configuration” of the fuel supply circuit 100, the greater the risk of the APU 107 shutting down. On the other hand, during the operation of fueling the trim tank 106 after the pressure switch 103 is replaced the duration of the “pre APU shutdown configuration” is below the first predetermined threshold S1 and the number of occasions of sudden shutting down of the APU 107 decreases. Tracking the duration of this so-called “pre APU shutdown configuration” therefore enables indirect surveillance of the state of the pressure switch 103 and if necessary issuing an alert necessitating maintenance of the equipment unit.

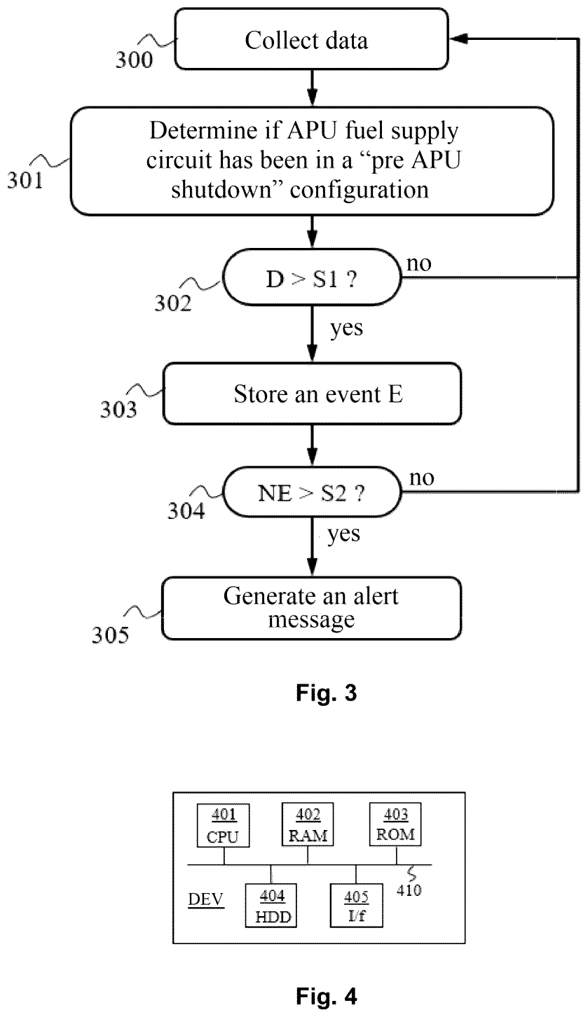

FIG. 3 is a diagram depicting the steps of a method in accordance with one embodiment for surveillance of an equipment unit such as a pressure switch of the fuel supply circuit of an APU.

The surveillance method described hereinafter is implemented by a surveillance device DEV described hereinafter with reference to FIG. 4.

Firstly, during a step 300 the surveillance device DEV collects data coming from at least one avionic system of the aircraft, for example an aircraft condition monitoring system (ACMS) or flight operations and maintenance exchanger (FOMAX) or retrofit maintenance exchanger (RMAX). This data is for example data transmitted by the aircraft after each flight to an operations center or to a maintenance center on the ground where it is stored in a database. This data in the database is then collected by the surveillance device DEV. The operations center is for example an operations center of the manufacturer of the aircraft providing services to assist with maintenance of aircraft belonging to airlines. The maintenance center is for example a maintenance center of the airline operating the aircraft. The data collected in the step 300 is data acquired by the avionic system of the aircraft over a predetermined data acquisition period P and at a predetermined data acquisition frequency F (e.g., 1 Hz or 2 Hz). In one example this predetermined period P corresponds to a number of flights of the aircraft. In another example this predetermined duration P is a number of days.

For each acquisition time in the predetermined period P (i.e., each time defined by the predetermined frequency F) the surveillance device DEV obtains data representing:
a measurement of the rotation speed of the APU 107; the surveillance device DEV can therefore determine the operating status of the APU 107; in fact, if the rotation speed of the APU 107 is greater than 0 RPM the surveillance device DEV determines that the operational status of the APU 107 is “on”; otherwise, the operating status is “off” (e.g., if the APU 107 shuts down suddenly because it suffers a dry fault during the operation of fueling the trim tank 106 or if the APU 107 is shut down intentionally because the main propulsion systems have been powered up);
an “open” or “closed” status of the inlet valve 109 of the trim tank 106; the surveillance device DEV then determines that if the status of the inlet valve for the trim tank 106 is “open” the trim tank 106 is being fueled and the operating mode of the fuel supply circuit 100 is “trim tank fueling”; if the status of the inlet valve 109 is “closed” (e.g., if the operation of fueling the trim tank 106 has finished or the pressure switch 103 detects a pressure of the fuel in the fueling pipe 104 below a predetermined threshold and that the fuel supply circuit 100 must be switched to the “operation on ground” mode) the fuel supply circuit 100 is in a different operating mode (e.g., the “operation on ground” mode); and
a measurement of the quantity of fuel in the trim tank 106; the surveillance device DEV then determines an “empty” or “non-empty” status of the trim tank 106; if the quantity of fuel is below a predetermined quantity of fuel Q threshold (for example 50 liters, i.e., around 100 pounds), then the surveillance device DEV determines the status of the trim tank 106 is “empty”; otherwise the surveillance device DEV determines that the trim tank is “non-empty”.

The surveillance device DEV then stores the collected data corresponding to the predetermined period P in a memory, for example in the form of a table in which each row corresponds to a set of collected data corresponding to a particular acquisition time in the predetermined period P (e.g., one row per second if the determined frequency F is 1 Hz), the data representing at this time:
a measurement of the rotation speed of the APU 107,
the status of the inlet valve 109 of the trim tank 106, and
a measurement of the quantity of fuel contained in the trim tank 106.

Each row is also date stamped. Each item of data collected is therefore associated with an acquisition date and time, for example.

The collected data is then processed by the surveillance device DEV. In particular, in a step 301 the surveillance device DEV determines if during the predetermined data acquisition period P the fuel supply circuit 100 was in a “pre APU shutdown configuration” as described above. In particular, the surveillance device DEV determines that the fuel supply circuit 100 was in a “pre APU shutdown configuration” when the APU 107 was in the “on” operating state and the operating mode of the fuel supply circuit 100 of the APU 107 was the “trim tank fueling” mode (i.e., the trim tank 106 was being fueled) and furthermore that the status of the trim tank 106 was “empty”.

Note that during the predetermined period P the fuel supply circuit 100 may have been in the “pre APU shutdown configuration” more than once.

In a step 302 the surveillance device DEV then determines a duration D during which this “pre APU shutdown configuration” was maintained. Eventually, if during the predetermined period P the fuel supply circuit 100 was in the “pre APU shutdown configuration” more than once, the surveillance device DEV then determines for each occurrence the duration D of the “pre APU shutdown configuration” detected.

In one example in which the collected data is stored in the form of a table as described above the surveillance device DEV then identifies the rows in which the fuel supply circuit 100 is in a “pre APU shutdown configuration” and then carries out a filtering operation in order to preserve only the rows corresponding to a fuel supply circuit 100 in the “pre APU shutdown configuration”. The surveillance device DEV then determines a ratio between the number of successive rows corresponding to the fuel supply circuit 100 in the “pre APU shutdown configuration” looked for to the predetermined data acquisition frequency. For example, if the predetermined data acquisition frequency is 2 Hz and 20 successive rows correspond to a fuel supply circuit 100 in the “pre APU shutdown configuration”, then the duration D of the “pre APU shutdown configuration” is 10 s.

If the fuel supply circuit 100 was in the “pre APU shutdown configuration” more than once the surveillance device DEV determines for each set of successive rows the ratio between the number of successive rows from all the rows to the predetermined data acquisition frequency.

Alternatively, the collected data being time stamped, the surveillance device DEV determines the duration D of the “pre APU shutdown configuration” by comparing the time-stamping of the data at the beginning (i.e. at the moment the “pre APU shutdown configuration” is detected by the surveillance device DEV) and the end of the “pre APU shutdown configuration” (i.e., the time at which the “pre APU shutdown configuration” is no longer detected by the surveillance device DEV).

Once the duration D of the “pre APU shutdown configuration” has been determined the surveillance device compares that duration D to a first predetermined threshold S1. In one example the first predetermined threshold S1 is around 75 seconds. If the duration D is above the first predetermined threshold S1 (“yes” result following step 302) then during a step 303 the surveillance device DEV stores in a memory an event E indicating that a duration D of the “pre APU shutdown configuration” is above the first predetermined threshold S1. On the other hand, if the duration D of the “pre APU shutdown configuration” is below the first predetermined threshold S1 (“no” result following step 302) step 300 is repeated.

In one embodiment if the duration D is above the first predetermined threshold S1 the surveillance device DEV compares the time stamps of the collected data on the basis of which the duration D was determined with the time stamps of the collected data on the basis of which the duration D′ of the most recent event stored in the memory was determined. If these time stamps are such that they correspond to the same use of the aircraft the surveillance device DEV compares the durations D and D′. If the duration D′ is greater than or equal to the duration D then the surveillance device DEV does not store the event E in the memory. If the duration D is greater than the duration D′ the surveillance device DEV stores the event E in the memory instead of the last event stored. Operation in this operating mode advantageously makes it possible to store at most only one event per use of the aircraft, namely the event for which the duration is the greatest. A use of the aircraft is a flight of the aircraft, in particular a part of the flight extending between starting preparation of the flight at a gate at a departure airport and the aircraft taking off from the departure airport.

In one embodiment during a step 304 the surveillance device DEV determines over the predetermined data acquisition period P a number of events NE (NE is an integer greater than or equal to 1) corresponding to the number of stored events indicating that the duration D is above the first predetermined threshold S1. If the number of events NE over the predetermined period P is above a second predetermined threshold S2 (“yes” result following step 303) the surveillance device DEV determines that the pressure switch 103 requires action and/or scheduling maintenance. An alert message is then generated during a step 305 described hereinafter. If not (“no” result following step 304) step 300 and the subsequent steps are repeated. In one particular example the predetermined period P is 50 days and the second predetermined threshold S2 is equal to 10.

In one embodiment during the step 305 the surveillance device DEV generates an alert message including a request to carry out and/or to schedule maintenance. In a variant, the alert message further includes information representing the duration D for which the “pre APU shutdown configuration” was maintained and/or a number of events NE, for example.

In one embodiment this alert message is a text message indicating that the pressure switch 103 requires action and/or scheduling maintenance.

In one embodiment this alert message is for example transmitted by the operations center or the maintenance center on the ground to a human-machine interface for the attention of personnel on the ground (e.g., a technician/operator).

The surveillance method as described hereinabove in its various embodiments enables indirect surveillance of an equipment unit of the fuel supply circuit 100 of the APU 107, such as the pressure switch 103. In other words, the surveillance method as described hereinabove enables implementation of a maintenance method for an equipment unit of the fuel supply circuit 100 of the APU 107, such as the pressure switch 103. In particular, thanks to the generation of an alert message, notably including a request for maintenance to be effected and/or scheduled, a technician/operator for example can carry out and/or schedule maintenance of this equipment unit (e.g., the pressure switch 103).

FIG. 4 depicts schematically one example of a hardware architecture of the surveillance device DEV that includes, connected by a communication bus 410: a central processing unit (CPU) 401, a random access memory (RAM) 402, a read only memory (ROM) 403, for example a Flash memory, a data storage device such as a hard disk drive (HDD) or a reader of storage media such as a secure digital (SD) card reader 404, and at least one communication interface I/f 405 enabling the surveillance device DEV to collect data received from an aircraft and to display an alert message in the operations center or the maintenance center on the ground.

The CPU 401 is able to execute instructions loaded into the RAM 402 from the ROM 403, an external memory (not represented), a storage medium such as an SD card, or a communication network (not represented). When the surveillance device DEV is powered up the CPU 401 is able to read and execute instructions from the RAM 402. Those instructions form a computer program causing the CPU 401 to execute the behavior steps and the algorithm described here.

Some or all of the behaviors and steps of the algorithm described here can therefore be implemented in software by execution of a set of instructions by a programmable machine such as a digital signal processor (DSP) or a microcontroller or be implemented in hardware by a dedicated machine or chip or a dedicated chipset such as a field-programmable gate array (FPGA) or an application-specific integrated circuit (ASIC). Generally speaking, the surveillance device DEV comprises electronic circuitry adapted and configured to implement the behaviors and steps and the algorithm described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for surveillance of an equipment unit of a fuel supply circuit of an auxiliary power unit of an aircraft, said method being implemented by a surveillance device comprising electronic circuitry, said method comprising:
determining when said fuel supply circuit was in a configuration during a predetermined period P in which these following conditions were fulfilled:
(i) said auxiliary power unit was in an “on” operating state, and
(ii) said fuel supply circuit was in a so-called “trim tank fueling” operating mode, and
(iii) said trim tank had a so-called “empty” fuel filling status;
for each time that the fuel supply circuit was in said configuration, determining a duration D during which said configuration was maintained and, when said duration D determined is above a first predetermined threshold, storing an event indicating that said determined duration D was above the first predetermined threshold; and,
determining for said predetermined period P a number of events stored and when said number of events determined is above a second predetermined threshold generating an alert message.

2. The method as claimed in claim 1, wherein the alert message includes a request for maintenance of said equipment unit to be effected, or scheduled, or both.

3. The method as claimed in claim 1, further comprising:
collecting first data representing said operating state of said auxiliary power unit during said predetermined period P, said first data consisting of measurements of a rotation speed of the auxiliary power unit, and determining that said auxiliary power unit is in the so-called “on” operating state when a rotation speed measurement is greater than 0;
collecting second data representing said operating mode of said fuel supply circuit during said predetermined period P, said second data consisting of a status of an inlet valve of the trim tank, and determining that the operating mode is the “trim tank fueling” mode when the status of the inlet valve is “open”; and,
collecting third data representing said fuel filling status of the trim tank during said predetermined period P, said third data consisting of measurements of a quantity of fuel in the trim tank, and determining that the status of the trim tank is “empty” when the quantity of fuel is below a predetermined fuel quantity Q threshold.

4. The method as claimed in claim 1, wherein the storing an event indicating that the duration D determined as being above the first predetermined threshold is carried out so as to store at most only one event during a single use of the aircraft.

5. A method for maintenance of an equipment unit of a fuel supply circuit of an auxiliary power unit of an aircraft, said method including:
surveillance of said equipment unit by performing the method as claimed in claim 1; and,
carrying out maintenance, or scheduling maintenance, or both on said equipment unit when the alert message is generated.

6. A device for surveillance of an equipment unit of a fuel supply circuit of an auxiliary power unit of an aircraft, said device including electronic circuitry configured to:
determine when said fuel supply circuit was in a configuration during a predetermined period P such that the following conditions were fulfilled:
(i) said auxiliary power unit was in an “on” operating state, and
(ii) said fuel supply circuit was in a so-called “trim tank fueling” operating mode, and
(iii) said trim tank had a so-called “empty” fuel filling status;
for each time that the fuel supply circuit was in said configuration, determine a duration D during which said configuration was maintained and, when said duration D determined is above a first predetermined threshold, to store an event indicating that said determined duration D was above the first predetermined threshold; and,
determine for said predetermined period P a number of events stored and when said number of events determined is above a second predetermined threshold generating an alert message.

7. A non-transitory computer readable storage medium comprising a computer program including instructions that, when executed by a processor, cause the processor to perform the method as claimed in claim 1.
